(19) United States
(12) Patent Application Publication
(10) Pub. No.: US 2015/0009674 A1
(43) Pub. Date: Jan. 8, 2015

(54) STRUCTURES SUBJECTED TO THERMAL ENERGY AND THERMAL MANAGEMENT METHODS THEREFOR

(71) Applicant: Ge Lighting Solutions, LLC, East Cleveland, OH (US)

(72) Inventors: Dengke CAI, Mayfield Heights, OH (US); Thomas CLYNNE, East Cleveland, OH (US); Péter JEZSOVICZKI, Budapest, (HU); Mark Edward KAMINSKI, Beachwood, OH (US); Elizabeth Anne SKIERSKI, Cleveland Heights, OH (US); Tomislav J. STIMAC, Concord, OH (US); Christopher Henry WILSON, Lachine (CA)

(21) Appl. No.: 13/934,399

(22) Filed: Jul. 3, 2013

(51) Int. Cl. F21V 29/00; B32B 27/32; B32B 15/085; F21V 7/20

(52) U.S. Cl. CPC F21V 29/244; F21V 7/20; B32B 27/322; B32B 15/085; B32B 2250/02; B32B 2307/416; B32B 2307/3065; B32B 2457/00; F21Y 2101/02
USPC 362/294; 428/421; 428/422; 428/339

(57) ABSTRACT

Thermal management techniques and methods for various types of structures that require a thermal property, such as thermal conductivity and/or flame retardance, and have a surface in proximity to a source of thermal energy. Such a structure includes a substrate formed of a metallic material or a thermally conductive plastic material, and a white fluoropolymer layer directly on a surface of the substrate without a discrete adhesive layer therebetween. The white fluoropolymer layer defines an outermost surface of the structure, has a reflectivity of greater than 95%, and has a thickness sufficient to inhibit degradation of the thermal property of the structure resulting from impingement of the surface by the thermal energy.

### FIELD

The present invention generally relates to thermal management of structures subjected to thermal energy, nonlimiting examples of which include lighting units that utilize one or more light-emitting diodes (LEDs) as a light source.

### BACKGROUND

As known in the art, LEDs (which as used herein also encompasses organic LEDs, or OLEDs) are solid-state semiconductor devices that convert electrical energy into visible light. More particularly, an LED typically comprises a chip (die) of a semiconducting material doped with impurities to create a p-n junction. The chip is electrically connected to an anode and cathode, all of which are often mounted within a package and encased with an encapsulant, for example, a silicone. Advances in LED technology have enabled high-efficiency LED-based lighting systems to find wider use in lighting applications that have traditionally employed other types of lighting sources, such as incandescent or fluorescent lamps. As an example, while LEDs have traditionally found uses in applications such as automotive, display, safety/emergency, and directed area lighting, LEDs are increasingly being used for area lighting applications in residential, commercial and municipal settings. A commercial example of an LED-based lighting unit suitable for area lighting applications is the General Electric Energy Smart® LED A19 bulb or lamp.

Area lighting applications typically require the delivery of significantly higher electrical power levels to an LED-based light source to produce greater amounts of light. A portion of the electrical power is converted into heat, which is preferably dissipated from the LED to promote the efficiency and reliability of the LED lighting unit. While incandescent and fluorescent lamps typically dissipate a significant amount of heat, e.g., via radiation through the lens of the lamp, this approach has been found to be inadequate for use in high power LED-based lighting units of types suitable for area lighting applications. Consequently, high power LED-based lighting units are often designed to dissipate heat via conduction by directly attaching the LED chip/package to a substrate capable of serving as a heat sink, and/or via convection and radiation with fins located externally of the LEDs. Various other thermal management techniques have also been proposed, such as active cooling techniques, nonlimiting examples of which are disclosed U.S. Patent Application Publication Nos. 2004/0190305 and 2012/0098425. While effective, thermal management systems can present a number of design challenges, particularly in view of the compact and lightweight designs typically desired for lighting units.

### BRIEF DESCRIPTION

The present invention provides thermal management systems and methods for various types of structures, for example, LED-based lighting units.

According to a first aspect of the invention, a structure is provided that requires a thermal property such as thermal conductivity and/or flame retardance, and has a surface in proximity to a source of thermal energy. The structure includes a substrate formed of a metallic material or a thermally conductive plastic material, and a white fluoropolymer layer directly on a surface of the substrate without a discrete adhesive layer therebetween. The white fluoropolymer layer defines an outermost surface of the structure, has a reflectivity of greater than 95%, and has a thickness sufficient to inhibit degradation of the thermal property of the structure resulting from impingement of the surface by the thermal energy.

According to a second aspect of the invention, an LED-based lighting unit is provided that includes a housing, a translucent portion coupled to the housing, and at least one LED adapted to emit visible light through the translucent portion. The LED generates thermal energy within the housing, and a structure is disposed in the LED-based lighting unit and is heated by the thermal energy generated by the LED. The structure has a surface within the housing in proximity to the LED such that light emitted by the LED impinges the surface of the structure, and a white fluoropolymer layer is directly on the surface of the structure without a discrete adhesive layer therebetween. The white fluoropolymer layer has a reflectivity of greater than 95% and reflects light that impinges the surface of the structure.

According to a third aspect of the invention, a method is provided for thermal management of an LED-based lighting unit that includes a housing, a translucent portion coupled to the housing, at least one LED emitting visible light through the translucent portion and generating thermal energy within the housing, and a plastic structure disposed in the LED-based lighting unit so as to be heated by the thermal energy generated by the LED. The plastic structure has a surface within the housing in proximity to the LED such that light emitted by the LED impinges the surface of the plastic structure. The method includes providing the surface of the plastic structure with a white fluoropolymer layer that directly contacts the surface thereof without a discrete adhesive layer therebetween. The white fluoropolymer layer has a reflectivity of greater than 95% and reflects light that impinges the surface of the plastic structure.

A technical effect of the invention is the ability of the white fluoropolymer layer to reflect light for the purpose of reducing radiation heat transfer to the plastic structure and/or promoting the reflection of visible light, a nonlimiting example of which is within an LED-based lighting unit. Preferred white fluoropolymer materials are effective at relatively low thicknesses, thermally stable at elevated temperatures, exhibit desirable flame retardance due to a relatively high limiting oxygen index, and can be applied to the plastic structure by various processes, including coating, overmolding, and co-extrusion techniques, without the need for an adhesive.

Other aspects and advantages of this invention will be better appreciated from the following detailed description.

### BRIEF DESCRIPTION OF THE DRAWINGS

FIG. 1 represents an LED-based lighting unit of a type capable of benefitting from the inclusion of a white fluoropolymer layer on internal surfaces within the unit.

FIG. 2 represents certain components of the lighting unit of FIG. 1, and identifies specific internal surfaces of the unit that can be protected by white fluoropolymer layers in accordance with preferred aspects of this invention.

FIGS. 3 and 4 schematically represent cross-sections of structures comprising a white fluoropolymer layer on a substrate in accordance with embodiments of the invention.

### DETAILED DESCRIPTION

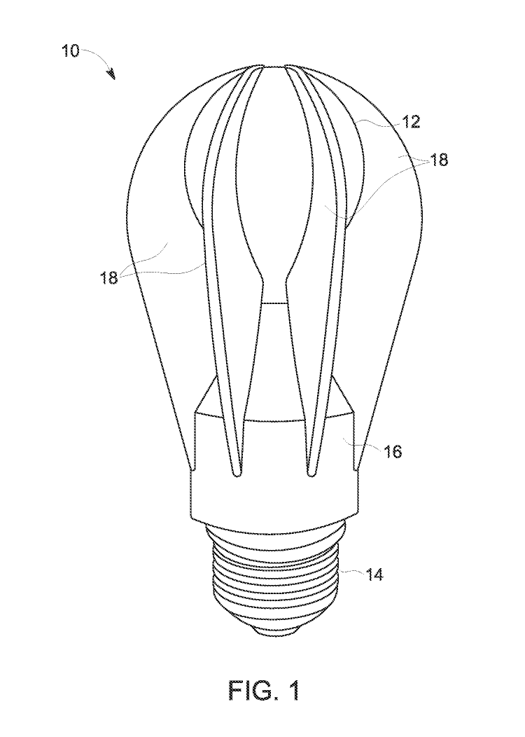

FIG. 1 represents an LED-based lighting unit 10 of a type commercially available. Specifically, the lighting unit 10 is represented as a General Electric Energy Smart® LED A19 bulb or lamp configured to provide a nearly omnidirectional lighting capability. However, it should be appreciated that LED-based lighting units of various other configurations are also within the scope of the invention.

As represented in FIG. 1, the unit 10 comprises a translucent spherical portion 12, an Edison-type threaded base connector 14, a housing or base 16 between the spherical portion 12 and the connector 14, and heat-dissipating fins 18 that enhance radiative and convective heat transfer from the base 16 to the surrounding environment. An LED-based light source (not shown), typically comprising multiple LED devices, is located at the lower end of the spherical portion 12 adjacent the base 16. In preferred embodiments of the invention, the LED devices are mounted on a printed circuit board (PCB) mounted to or within the base 16, and may be encapsulated on the PCB, for example, with an index-matching polymer to enhance the efficiency of visible light extraction from the LED devices. The base 16 typically contains driving electronics (not shown) and preferably also a heatsink on which the PCB and LEDs may be mounted for the purpose of conducting heat from the LED devices to the fins 18. As known in the art, the driving electronics are adapted to convert A.C. power received at the connector 14 to a form suitable for driving the LED devices, though it is foreseeable that this function could be omitted if the LED devices are configured to be operated directly from the power received at the connector 14.

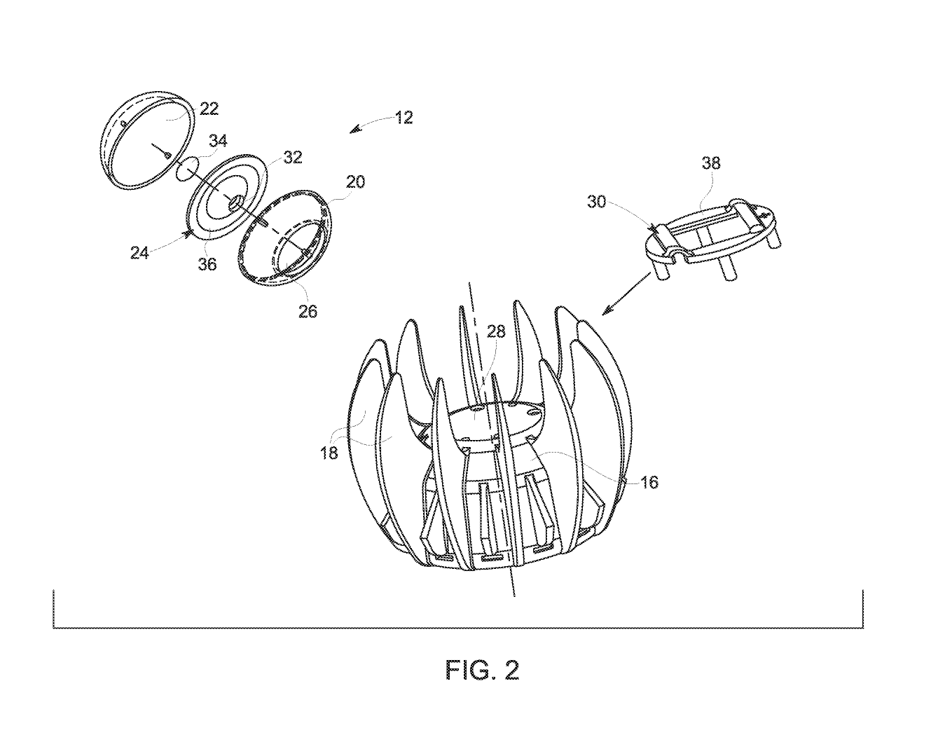

The configurations of the base 16 and fins 18 are adapted to minimize the size of the PCB on which the LED devices are mounted, which in turn promotes the capability of the unit 10 to emit visible light in a nearly omnidirectional manner through the spherical portion 12. FIG. 2 represents certain individual components of the unit 10 that provide or otherwise promote the omnidirectional capability of the unit 10. In particular, FIG. 2 represents the spherical portion 12 as an assembly comprising lower and upper translucent diffusers 20 and 22, between which an internal reflector 24 is disposed such that the reflector 24 is spaced apart from the LED devices. The lower translucent diffuser 20 has an opening 26 correspondingly sized with a surface 28 of the base 16 or its heatsink on which the PCB (not shown) and its LED devices can be mounted with a cover 30, such that visible light generated by the LED devices is directed into the interior of the spherical portion 12 defined by the diffusers 20 and 22. A portion of the generated light is reflected by the reflector 24 into the semispherical portion of the interior defined by the diffuser 20, through which the reflected light is distributed to the environment surrounding the unit 10. The remainder of the generated light passes through an opening 32 in the reflector 24 and then through an intermediate diffuser 34 before entering the semispherical portion of the interior defined by the diffuser 22, through which the passed light is distributed to the environment surrounding the unit 10. Materials commonly employed to produce certain components of the unit 10, including the reflector 24 and PCB cover 30, include polyimides (nylon), polycarbonate (PC), and polypropylene (PP). For use in the reflector 24 and cover 30, these materials have typically contained a filler, for example, titania (TiO₂,) to achieve a white reflective appearance. In addition, for use in electrical appliances such as the lighting unit 10, these materials are required to meet flame retardance standards, for example, UL (Underwriter Laboratories, Inc.) and CE (Conformité Européenne) standards.

In view of the above construction, it can be appreciated that visible light (and other electromagnetic wavelengths) generated by the LED devices impinge a surface 36 of the reflector 24 facing the LED devices, and light reflected by the reflector 24 impinges surfaces 38 of the PCB cover 30 facing the reflector 24. Consequently, the reflector 24 and cover 30 are likely to be exposed to thermal and optical degradation by heat and flux (for example, ultraviolet (UV) and high-intensity blue flux) generated by the LED devices. PC and other polymer materials having a white reflective appearance can be susceptible to heat and flux (for example, UV and high-intensity blue flux) generated by LED devices.

According to one aspect of the invention, at least the surfaces 36 and 38 of the reflector 24 and PCB cover 30 may be provided with a substantially opaque layer formed of a white fluoropolymer material that enables the surfaces 36 and 38 of the reflector 24 and cover 30 to have high optical reflectivities, preferably greater than 95%, for the purpose of reducing radiation heat transfer to the reflector 24 and cover 30 and promoting their ability to reflect visible light. Additionally, preferred white fluoropolymer materials are electrically insulating, stable at temperatures of at least 150° C., more preferably at least 260° C., and exhibit oxygen and humidity resistance, do not absorb high-intensity near-UV/blue flux (wavelengths of 350 to 800 nm), and are capable of serving as a flame-retardant barrier. With such capabilities, white fluoropolymer layers of this invention may allow for the reflector 24 and PCB cover 30 to be thinner than otherwise possible if these components were formed of, for example, Nylon, PC, or PP. As a nonlimiting example, the substrates of the reflector 24 and/or cover 30 overlaid by the white fluoropolymer layer may have a thickness normal to its surface 36 or 38 of up to about 2000 micrometers.

In addition to nylon, PC, and PP, the fluoropolymer layer may permit the use of a wide variety of relatively low-cost polymers for the substrate materials of the reflector 24 and cover 30, nonlimiting examples of which include ultrahigh molecular weight polyethylene (UHMW-PE), fluorinated ethylene propylene (FEP), rubber, etc. In certain embodiments, the PCB cover 30 may be configured to assist in conducting heat from the PCB to the base 16, from which the heat can be dissipated by the fins 18 to the surrounding environment. For this purpose, the cover 30 and/or portions of the base 16 may be formed of thermally-conductive plastic (TCP) materials, nonlimiting examples of which include plastic matrix materials in which is dispersed one or more conductive fillers that have a higher thermal conductivity than the plastic matrix material. Particular but nonlimiting examples of conductive fillers include metals, a notable example of which is silver, and carbonaceous materials, notable examples of which include graphene, carbon nanotubes, etc. TCP materials with such fillers may absorb visible light and have low reflectivity. In the case of the PCB cover 30 and other components that are desired to be thermally conductive, the optical reflectance of the white fluoropolymer layer may permit a TCP used to form the component to have a higher conductive filler content to promote its thermal conductivity and also meet flame retardance and electrical standards.

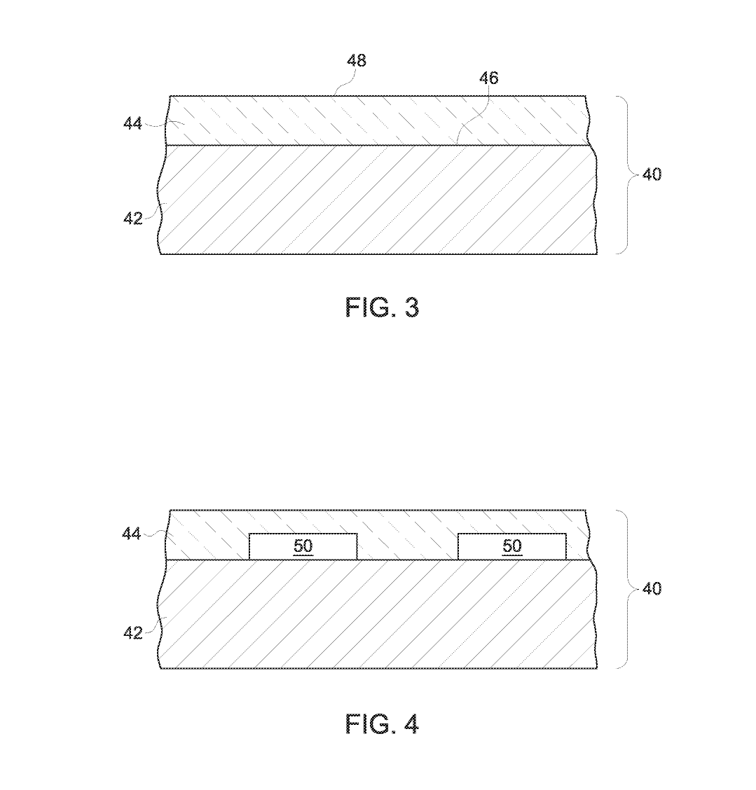

In addition to the lighting application described above in reference to FIG. 2, a broader aspect of the invention is for the use of a white fluoropolymer layer on a wider variety of substrate materials, particularly substrate materials that require relatively high thermal conductivity, for example, substrates formed of a metallic or TCP material. Such substrate materials may alternatively or in addition have a flame-retardant requirement, for example, UL standards for flame retardance, most notably the UL 94 standard for plastic materials. FIG. 3 schematically represents a cross-section of a structure 40 comprising a thermally conductive substrate 42 and a white fluoropolymer layer 44 of this invention, wherein the fluoropolymer layer 44 directly contacts a surface 46 of the substrate 42 and defines an outermost surface 48 of the structure 40 that is or will be subjected to thermal energy that would otherwise be capable of degrading the properties of the substrate 42. FIG. 4 schematically represents the same or different structure 40 as a PCB, for example, the aforementioned PCB on which LED devices are mounted for use in an LED-based light source. The structure 40 is represented as having circuit components 50 mounted thereon, and the white fluoropolymer layer 44 as directly contacting and enclosing the circuit components 50 on the substrate 42. In such an embodiment, the white fluoropolymer layer 44 can function as an electronic enclosure to promote the ability of the LED-based light source and its PCB to meet regulatory flame retardance and electrical requirements and, if applicable, also promote optical and thermal performances.

According to a preferred aspect of the invention, the structure 40 lacks an intermediate adhesive between the fluoropolymer layer 44 and the substrate 42. Particularly in the context of lighting applications described in reference to FIG. 2, the elimination of an adhesive is capable of providing certain important benefits. As an example, the elimination of an adhesive can facilitate the application of the fluoropolymer layer 44 to relatively complicated shapes (for example, where the surface 46 of the substrate 42 is nonplanar). In addition, the absence of an intermediate adhesive avoids outgassing issues that may occur during the curing of an adhesive, as well as avoids property losses that can be associated with adhesives, for example, reduced thermal conductivity.

In the case where the substrate 42 is formed of a TCP material, a notable aspect of the invention is the possibility of the fluoropolymer layer 44 to promote the flame retardance of the structure 40, as discussed above. For example, the white fluoropolymer layer 44 may allow for the substrate 42 and possibly the entire structure 40 to be thinner than otherwise possible if the substrate 42 were formed of, for example, nylon, PC, or PP. As a nonlimiting example, a structure 40 having a cross-section similar to what is shown in FIG. 3 and whose fluoropolymer layer 44 has a thickness of about 50 micrometers or more may permit a reduction in the thickness of the substrate 42 of about 50 percent or more relative to the same substrate material in the absence of the fluoropolymer layer 44, while still meeting the UL 94 standard for plastic materials.

Particularly preferred fluoropolymer materials are believed to be crystalline-type fluoropolymers, including polytetrafluoroethylene (PTFE), fluoroethylene vinyl ether, ethylene tetrafluoroethylene, polyvinyl fluoride (PVF), polyvinylidene fluoride, perfluoroalkoxy, fluorinated ethylene propylene, and polyvinylidene fluoride (PVDF). These fluoropolymer materials are capable of forming a white fluoropolymer layer having a reflectance of greater than 95% over a wavelength region of 350 nm to 800 nm, and can do so without requiring a filler that promotes optical scattering. Alternatively or in addition, amorphous fluoropolymers can be used, a notable example of which is CYTOP® commercially available from the Asahi Glass Company (AGC), Ltd. To be optically opaque, investigations leading to the present invention indicated that a white fluoropolymer layer formed of PTFE should have a thickness of at least 50 micrometers, more preferably at least 100 micrometers, with a suitable upper limit being about 300 micrometers, though greater thicknesses are foreseeable. To decrease the thickness of the fluoropolymer layer required to achieve a desired level of reflectivity through optical scattering, these fluoropolymers can be combined with organic and/or inorganic fillers, for example, refractive index mismatched particles of titania (TiO₂), PTFE, etc.

White fluoropolymer layers of the present invention can be formed using various processes. For example, the white fluoropolymer layer 44 represented in FIG. 3 can be deposited on the surface 46 of the substrate 42 as an aqueous solution (with or without fillers) that can be processed and cured to form a discrete coating, or formed by a thermo-forming or molding process, for example, by overmolding or co-extrusion with the substrate material to be protected with the layer 44. As noted above, a preferred aspect of the invention is that an intermediate adhesive is not required to adhere the fluoropolymer layer 44 to its underlying substrate 42.

While the invention has been described in terms of specific embodiments, it is apparent that other forms could be adopted by one skilled in the art. Therefore, the scope of the invention is to be limited only by the following claims.

1. A structure having a surface in proximity to a source of thermal energy and required to have at least one of thermal property chosen from the group consisting of thermal conductivity and flame retardance, the structure comprising:
a substrate formed of a metallic material or a thermally conductive plastic material; and
a white fluoropolymer layer directly on a surface of the substrate without a discrete adhesive layer therebetween, the white fluoropolymer layer defining an outermost surface of the structure, having a reflectivity of greater than 95%, and having a thickness sufficient to inhibit degradation of the thermal property of the structure resulting from impingement of the surface by the thermal energy.

2. The structure according to claim 1, wherein the white fluoropolymer layer comprises at least one fluoropolymer chosen from the group consisting of polytetrafluoroethylene, fluoroethylene vinyl ether, ethylene tetrafluoroethylene, polyvinylfluoride, polyvinylidene fluoride, perfluoroalkoxy, fluorinated ethylene propylene, polyvinylidene fluoride, and amorphous fluoropolymers.

3. The structure according to claim 1, wherein the white fluoropolymer layer has a thickness of about 50 micrometers to about 300 micrometers.

4. The structure according to claim 1, wherein the white fluoropolymer layer has a reflectance of greater than 95% between wavelengths of about 350 to about 800 nanometers.

5. The structure according to claim 1, wherein the white fluoropolymer layer is thermally stable to a temperature above 150° C.

6. The structure according to claim 1, wherein the structure is an optical reflector spaced apart from an LED and adapted to reflect visible light generated by the LED.

7. The structure according to claim 1, the structure comprises a printed circuit board on which an LED and circuit components are mounted, and the white fluoropolymer layer directly contacts and encloses the circuit components on the printed circuit board.

8. An LED-based lighting unit comprising:
a housing;
a translucent portion coupled to the housing;
at least one LED adapted to emit visible light through the translucent portion, the LED generating thermal energy within the housing;
a structure disposed in the LED-based lighting unit so as to be heated by the thermal energy generated by the LED, the structure having a surface within the housing in proximity to the LED such that light emitted by the LED impinges the surface of the structure; and
a white fluoropolymer layer directly on the surface of the structure without a discrete adhesive layer therebetween, the white fluoropolymer layer having a reflectivity of greater than 95% and reflecting the light that impinges the surface of the structure.

9. The LED-based lighting unit according to claim 8, wherein the structure is a thermally-conductive plastic.

10. The LED-based lighting unit according to claim 9, wherein the thermally-conductive plastic comprises a plastic matrix material in which a filler is dispersed having a thermal conductivity higher than the plastic matrix material, the structure conducting heat from the LED.

11. The LED-based lighting unit according to claim 9, the LED-based lighting unit further comprising a printed circuit board on which the LED is mounted, the structure being a cover contacting the printed circuit board.

12. The LED-based lighting unit according to claim 8, wherein the structure is an optical reflector spaced apart from the LED and adapted to reflect visible light generated by the LED.

13. The LED-based lighting unit according to claim 8, wherein the white fluoropolymer layer is a coating formed as a deposit on the surface of the structure.

14. The LED-based lighting unit according to claim 8, wherein the white fluoropolymer layer is an overmold on or a co-extrusion with the structure.

15. The LED-based lighting unit according to claim 8, wherein the white fluoropolymer layer comprises at least one fluoropolymer chosen from the group consisting of polytetrafluoroethylene, fluoroethylene vinyl ether, ethylene tetrafluoroethylene, polyvinylfluoride, polyvinylidene fluoride, perfluoroalkoxy, fluorinated ethylene propylene, polyvinylidene fluoride, and amorphous fluoropolymers.

16. The LED-based lighting unit according to claim 8, wherein the white fluoropolymer layer has a thickness of about 50 micrometers to about 300 micrometers.

17. The LED-based lighting unit according to claim 8, wherein the white fluoropolymer layer has a reflectance of greater than 95% between wavelengths of about 350 to about 800 nanometers.

18. The LED-based lighting unit according to claim 8, wherein the white fluoropolymer layer is thermally stable to a temperature above 150° C.

19. The LED-based lighting unit according to claim 8, wherein the structure has a thickness normal to the surface thereof of up to about 100 micrometers.

20. A thermal management method for an LED-based lighting unit, the LED-based lighting unit comprising a housing, a translucent portion coupled to the housing, at least one LED emitting visible light through the translucent portion and generating thermal energy within the housing, and a structure disposed in the LED-based lighting unit so as to be heated by the thermal energy generated by the LED, the structure having a surface within the housing in proximity to the LED such that light emitted by the LED impinges the surface of the structure, the method comprising:
providing the surface of the structure with a white fluoropolymer layer that directly contacts the surface thereof without a discrete adhesive layer therebetween, the white fluoropolymer layer having a reflectivity of greater than 95% and reflecting the light that impinges the surface of the structure.
